(19) United States
(12) Patent Application Publication
(10) Pub. No.: US 2014/0058959 A1
(43) Pub. Date: Feb. 27, 2014

(54) METHOD AND SYSTEM FOR ENFORCING 3D RESTRICTED RIGHTS IN A RAPID MANUFACTURING AND PROTOTYPING ENVIRONMENT

(71) Applicants: Kimmo ISBJORNSSUND, Tallinn (EE); Anton VEDESHIN, Tallinn (EE)

(72) Inventors: Kimmo ISBJORNSSUND, Tallinn (EE); Anton VEDESHIN, Tallinn (EE)

(21) Appl. No.: 13/973,816

(22) Filed: Aug. 22, 2013

(30) Foreign Application Priority Data
Aug. 21, 2012 (EP) EP12181430.5

(51) Int. Cl. G06Q 50/18; G06Q 10/10

(52) U.S. Cl. CPC G06Q 50/184; G06Q 10/10
USPC 705/310

(57) ABSTRACT

A system and method of enforcing 3D restricted rights in a rapid manufacturing and prototyping environment may include, in response to receiving a 3D object data representative of a 3D object, performing at least one function on the 3D object data to determine a parameter set for each respective function. Business rule(s) may be applied to each parameter set for each respective function. At least one algorithm may be performed to determine whether at least a portion of the 3D object matches a rights restricted 3D object. In response to determining that at least a portion of the 3D object matches a restricted rights 3D object, an action may be caused to be taken, otherwise, in response to determining that at least a portion of the 3D object does not match a restricted rights 3D object, the 3D object may be enabled to be rapid manufactured or prototyped.

### RELATED APPLICATIONS

This application claims priority to co-pending EP12181430.5-1243 filed Aug. 22, 2012, the contents of which are hereby incorporated by reference in their entirety.

### FIELD OF THE INVENTION

The principles of the present invention relate to electronic devices, such as rapid manufacturing devices and systems, either by additive or subtractive methods, including 3D printing devices, with intellectual property rights enforcement features using CAD physical 3D model comparisons to enforce other type of use restrictions.

### BACKGROUND

Rapid manufacturing and rapid prototyping are relatively new class of technologies that can automatically construct physical 3D models from Computer-Aided Design (CAD) data. Usually these methods make use of additive manufacturing technologies, including 3D printers.

3D printing or additive manufacturing (AM) is a process of joining materials to make objects from 3D model data, usually layer upon layer, as opposed to subtractive manufacturing methodologies, such as traditional machining. Several technologies are available for industrial uses, including for rapid prototyping and rapid manufacturing, but increasingly also for domestic and hobbyist uses. 3D printing is rapidly becoming as widespread as traditional 2D printing had become long ago.

Combining 3D printing with 3D scanning also makes possible 3D copying, i.e., a process where first a 3D digital model of an object is made by 3D scanning of the object and then a 3D copy of the 3D object is made by 3D reproducing similarly to the process of digital 2D copying.

It is well known that 2D printing and copying can be used to make copies of copyrighted materials or other materials protected by other intellectual property rights. While some technologies exist to inhibit copying, e.g., documents with security features, such as watermarks, holograms, straps, UV or IR glowing, etc; however, no universal technology exists to control reproducing and copying of copyrighted materials or other protected materials.

The same challenges are maybe even more important in 3D printing and copying. For example, 3D objects can be protected by number of intellectual property rights, including copyright (e.g., as sculptures, figurines, architectural objects, etc.), industrial design (known in the U.S. as a design patent; e.g., a new shape of a product such as vase or chair), 3D trademark or even by a patent (design patent in the US) or a utility patent. While certain fair use provisions may exist in copyright law (or analogous provisions for design patent or utility patent) allowing in some cases making copies for non-commercial private use, making copies of such 3D objects protected by intellectual property rights is prohibited without a prior explicit permission (a license) from the rights holder.

Also, no universal technologies exist allowing rights holders to make their IPR protected materials available for 3D reproducing against payment of fee.

What is needed, therefore, is a method for managing and controlling, including enforcing intellectual property rights and other restrictions in a rapid manufacturing and prototyping environment. Also needed is a 3D reproducing system with intellectual property rights management feature.

### SUMMARY

One aspect of the invention is a method for enforcing 3D intellectual property rights in a rapid manufacturing and prototyping environment for manufacturing 3D objects. The method may include receiving, by a computer system, an inquiry whether a mechanical reproduction of a 3D object or of at least one part of said 3D object is restricted by law or by third person's rights. The 3D object may be presented as an electronic file accessible in a computer system. A determination by the computer system from a 3D restricted rights database as to whether any restrictions exist for the mechanical reproduction of the 3D object or at least one part of the 3D object may be made. A response may be made by a computer to the inquiry, where the response includes information on the restrictions or information that no restrictions exist in 3D restricted rights database. The determination may include performing a 3D object comparison between at least a portion of 3D objects.

The 3D restricted rights database may include a database of 3D intellectual property rights. The restricted rights database may also include a database of 3D items, the mechanical reproduction of which is prohibited or restricted by law, for example, weapons, firearms or their parts, explosives, etc., or restricted by other types of rights, e.g., privacy rights such as personality rights, rights to personal image (likeness) or contractual rights (e.g., terms of use of a 3D model database).

According to one embodiment, the inquiry is a request from an end user to reproduce a 3D object by using rapid manufacturing or prototyping tools connected directly or over a computer network to the computer system from an electronic file of the 3D object. The method may include the computer system determining if the 3D object or at least one of its parts is included in the 3D restricted rights database. The determination can be accomplished by comparing the 3D object, the electronic file of the 3D object or a unique identification code of the 3D object stored directly in the 3D object or attached to the electronic file of the 3D object, with corresponding records of the 3D restricted rights database. The method may further include the computer system retrieving such restriction information from said 3D restriction database, and then taking an affirmative action based on such restriction information. Such affirmative action may be one or more actions, including (i) sending a notice to the user that the 3D object is protected, e.g., by intellectual property rights, sending a warning to the user that reproduction of the 3D object is illegal, prohibited or restricted, (ii) stopping the tools from reproducing the 3D object, (iii) stopping the computer system from copying, alternating, moving, removing or streaming of the 3D object and its electronic file, or (iv) offering the user a license for fee or for free.

According to one embodiment, the method may include offering the user a license or permission to reproduce the 3D object, receiving an acceptance from the user of the terms of the offer, and delivering the 3D object to a rapid manufacturing or prototyping tool over a secure channel. Such method may include receiving a payment from the user by any known means, including but not limited to using credit or debit card payments, using pre-payment account, using gift cards or vouchers, making a wire transfer using Internet banking, or using electronic payment services, such as PayPal, etc. The method further comprises providing the user, the electronic file, or the rapid manufacturing or the rapid prototyping tool with a unique identification code necessary for reproducing the 3D object.

According to one embodiment, the inquiry is a request from said rapid manufacturing or prototyping tool, such as 3D printer. Such method may further include providing said rapid manufacturing or prototyping tool with a unique identifier necessary for reproducing the 3D object. The unique identifier is a device specific identifier, associated in a computer system as authorized to reproduce at least one 3D object, and, at the request to print the at least one 3D object, delivering (e.g., sending or streaming) the 3D object to said rapid manufacturing or prototyping tool over a secured data loss proof channel.

According to one embodiment, the method may include securely storing a list of unique 3D model specific identifying codes on the rapid manufacturing or prototyping tool, such as 3D printer, for checking the restrictions by the rapid manufacturing or prototyping tool itself without the need for continuous real time connection with the 3D restricted rights database. The method may further include updating the list of unique 3D model specific identifying codes from the 3D restricted rights database when the rapid manufacturing or prototyping tool is connected with the 3D restricted rights database over the computer network. Such unique 3D model specific identification codes may be hashes, obfuscated 3D models, Copyright identifiers CIDs, License identifiers LIDs and Anti-Piracy Identifiers APIDs, or a combination of these, or other calculation methods.

According to one embodiment, the method may include updating the 3D restricted rights database by a rights holder. Such method comprises uploading a new 3D model, representing 3D object, into the restricted rights database, defining part or parts of the 3D object, the use of which is restricted, and providing the terms for reproducing said 3D object or part or parts of the 3D object.

According to the embodiments of the invention, the inquiry may be received from different sources of 3D models, including, but not limited to a third-party 3D model shop, a 3D scanning device, a 3D computer-aided design software, a 3D model community, a 3D modeling database, etc.

According to one embodiment, the method may include receiving an inquiry from a 3D scanning device (3D scanner) at the time of scanning a 3D object, and providing the electronic file generated by the 3D scanning device, or the 3D model with a 3D model specific identification code for determining whether reproducing the 3D object is restricted or prohibited.

The principles of the present invention may also include a system for enforcing intellectual property rights in a rapid manufacturing and prototyping environment. The system may include a source of 3D objects, such as an online shop for 3D models, an online databank of 3D objects, 3D modeling service or other online services, or simply 3D scanning device. The system may further include a restricted rights database, where the restricted rights database may be accessible over an Internet or local computer network (including, but not limited to that the restricted rights database is stored in a “cloud”), an end-user device, connected to the Internet and to a rapid manufacturing and prototyping device (such as 3D printer), which, in turn, is connected both to the end user device and to the Internet, and a restricted rights management application. The 3D restricted rights database may include a 3D intellectual property rights database and a database of 3D items, which mechanical reproduction is prohibited by law. The restricted rights management application may include a 3D objects similarity check module, a Web Application Programming Interface for receiving inquiries from the source of 3D objects, a web based user interface (Web UI), 3D printers API for communicating with 3D printers checking every 3D object to be printed against objects in IPR database, Licensing Module for allowing the user to obtain a license necessary for mechanically reproducing the 3D object, a Royalty Payment Transaction Module allowing the user to pay any license fees necessary, and 3D Object streamer for streaming of 3D object data through Internet or LAN directly to the rapid manufacturing or prototyping tool over a secure channel. In this application, the “cloud” is defined as one or many computers or hardware or software computer systems, which store, process and distribute data.

One embodiment of a method of enforcing 3D restricted rights in a rapid manufacturing and prototyping environment may include, in response to receiving a 3D object data representative of a 3D object, performing, by a computing device, at least one function on the 3D object data to determine a parameter set for each respective at least one function. At least one business rule may be applied to each parameter set for each respective at least one function. At least one algorithm may be performed to determine whether at least a portion of the 3D object matches a rights restricted 3D object. In response to determining that at least a portion of the 3D object matches a restricted rights 3D object, an action may be caused to be taken, otherwise, in response to determining that at least a portion of the 3D object does not match a restricted rights 3D object, the 3D object may be enabled to be rapid manufactured or prototyped.

In addition, a determination as to whether the at least a portion of the 3D object matches a rights restricted 3D object may include determining a probability factor that the at least a portion of the 3D object matches the rights restricted 3D object. The function(s) may include characterizing the 3D object or portion thereof from the 3D object data. The characterization may include calculating a number of vertices of which the 3D object includes. Applying the at least one business rule may include checking the parameter set and making a determination based on the parameter set. Making a determination on the parameter set may include making a determination that the 3D object is a firearm or weapon. Making a determination may include voting, using the 3D object data set, for a particular 3D object device represented by the 3D object data. The 3D object data may be normalized prior to performing the at least one function. The normalization may include scaling the 3D object data to be comparable to other 3D object data representative of the rights restricted 3D object to which the 3D object is to be compared. A database of rights restricted 3D objects may be data mined using parameters generated from normalizing the 3D object data. Causing an action to be taken may include preventing the 3D object to be rapid manufactured or prototyped.

One embodiment of a system of enforcing 3D restricted rights in a rapid manufacturing and prototyping environment may include a storage unit configured to store restricted right 3D objects. A memory may be configured to store data. A computing device may be in communication with the storage unit and memory, and be configured to, in response to receiving a 3D object data representative of a 3D object, perform at least one function on the 3D object data to determine a parameter set for each respective at least one function. At least one business rule may be applied to each parameter set for each respective at least one function. At least one algorithm may be performed to determine whether at least a portion of the 3D object matches a rights restricted 3D object. In response to determining that at least a portion of the 3D object matches a restricted rights 3D object, an action may be caused to be taken, otherwise, in response to determining that at least a portion of the 3D object does not match a restricted rights 3D object, the 3D object may be enabled to be rapid manufactured or prototyped.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of a system for providing restricted rights management for rapid manufacturing according to one embodiment of the invention;

FIG. 2 is an illustration of a more detailed system of FIG. 1 according to another embodiment of the invention;

FIG. 3 is a flow diagram of an illustrative process for providing restricted rights management for rapid manufacturing in accordance with the principles of the present invention;

FIG. 4 is a block diagram of an illustrative process for processing 3D objects to determine whether the 3D objects or a portion thereof are original and/or have restricted rights associated therewith;

FIG. 5 is a block diagram of an illustrative architecture for determining design originality and/or restricted rights status of a 3D object;

FIG. 6 is an illustration of an illustrative triangular facet that may be used in determining originality and/or restricted rights of a 3D object;

FIG. 7 is an illustration of an illustrative 3D object with triangular facets representing the skeleton of the 3D object;

FIG. 8 is a flow diagram of an illustrative system and process for use in classifying 3D objects;

FIG. 9 is an illustration of an illustrative object skeleton for use in determining design originality and/or restricted rights status of a 3D object;

FIG. 10 is an illustration of an illustrative 3D model represented by triangular facets for a surface of the 3D model;

FIG. 11 is an illustrative progressive detailization of a 3D object for use in describing a 3D model;

FIG. 12 is a pair of illustrations that show a 3D object, in this case torus structures, with a complex outer skeleton simplified through use of a truncation process that represents the 3D object;

FIG. 13 is an illustration of an illustrative automobile with a truncation skeleton of the outer portion of the automobile;

FIG. 14 is an illustrative architectural view of a software solution according to one embodiment of the invention; and

FIG. 15 is an illustrative technical view of the software solution according to one embodiment of the invention.

### DETAILED DESCRIPTION

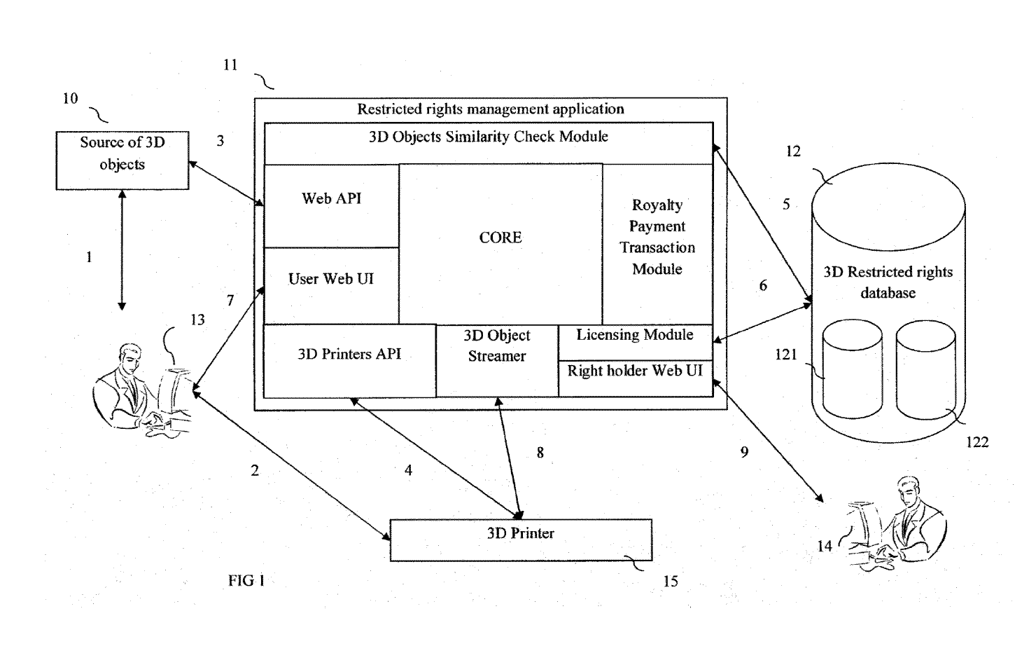

A system for enforcing 3D restricted rights (RR) in a rapid manufacturing and prototyping environment according to one embodiment of the invention is shown in FIG. 1. The system may include a source of 3D objects 10, such as an online shop for 3D models, an online databank of 3D objects, 3D modeling service or other online services, a 3D computer-aided design (CAD) software, or simply a 3D scanning device. The end-user can access the source of 3D objects 10 over the Internet, or over a local area network (LAN), using the end user device 13. The system further comprises restricted rights RR management application 11. The RR management application 11 comprises a 3D objects Similarity Check Module, a Web Application Interface (Web API) for receiving restricted rights related inquiries from the source of 3D objects 10, a web based user interface (Web UI), 3D printers API for communicating with 3D printers 15 checking every 3D model to be printed against objects in RR database 12, Licensing Module for providing the user with necessary license for reproducing the 3D object, a Royalty Payment Transaction Module allowing the user to pay any license fees required, a 3D Object streamer for streaming of 3D object data through Internet or LAN directly to the 3D printer 15, and a core for operating the RR management application. The RR management application also has a rights holder Web user interface so that the rights holder can upload new 3D objects into RR database and modify rights associated with such 3D objects, using rights holder device 14. 3D object is a physical object to be manufactured, and 3D model is defined as any computer 3D representation of such 3D object, such as file or files(s) in any of the computer aided design (CAD) file format, STL file(s), or additive manufacturing file format. (for example, 0.3ds, .MDX, 0.3CT, ACIS, ArchiCAD library part, BE-Bridge, CAD data exchange, COLLADA, AutoCAD DXF, Design Web Format, DGN, .dwg, Geometric Description Language, IGES, KernelCAD, Open Design Alliance, OpenCTM, Parasolid, PLY, PRC, Product data record, Revizto, STL, VDA 6.1, VDA-FS, Wavefront .obj). It can also be one or more files providing views of the 3D object in any image file format.

The system as shown in FIG. 1 may be used as follows. The user may request a 3D object using end-user device 13 from a source of 3D objects (step 1) to be reproduced using the 3D printer 15 (step 2). The source of 3D objects sends an inquiry to the RR management application through the WebAPI (step 3). In one embodiment, the 3D printer includes a software code or a hardware device installed that requires, through a 3D printers API, for every 3D model to be printed with a confirmation from the RR management application that reproducing of the 3D model is not restricted (step 4). The restricted rights management application checks if restrictions exist in RR database (step 5). If so, the Licensing Module is initiated (step 6), and the end-user is offered a license. The Licensing Module may be adapted to provide any type of license, including single, multiple or other types of licenses for reproducing authorized restricted rights 3D models. The end-user can communicate with the RR management application via the end-user device 13 through the user Web UI (step 7). If the license terms include royalty payments, the Royalty Payment Transaction Module is initiated and the end-user is provided with opportunity to pay for the license. Then, the 3D printer 15 is provided with a confirmation that the 3D model can be printed, and the 3D model is delivered (sent, streamed) to the 3D printer through 3D Object streamer (step 8).

The system allows the rights holder via a rights holder device 14 to update the RR database to upload new 3D objects together with their restriction terms (step 9).

The WebAPI can support authentication, secured 3D model transfer, or other restricted rights requests. The Web API can be implemented, e.g., using Secured SOAP, REST, HTTP with, e.g., OAuth (open source) authentication, or other suitable means.

The 3D streamer can be implemented, e.g., using RTMPS (real time messaging protocol over a secure SSL connection using HTTPS), FDT (fast data transfer), 3TP (an application layer protocol for streaming 3D graphics), a proprietary protocol developed for restricted rights management application, or other suitable means.

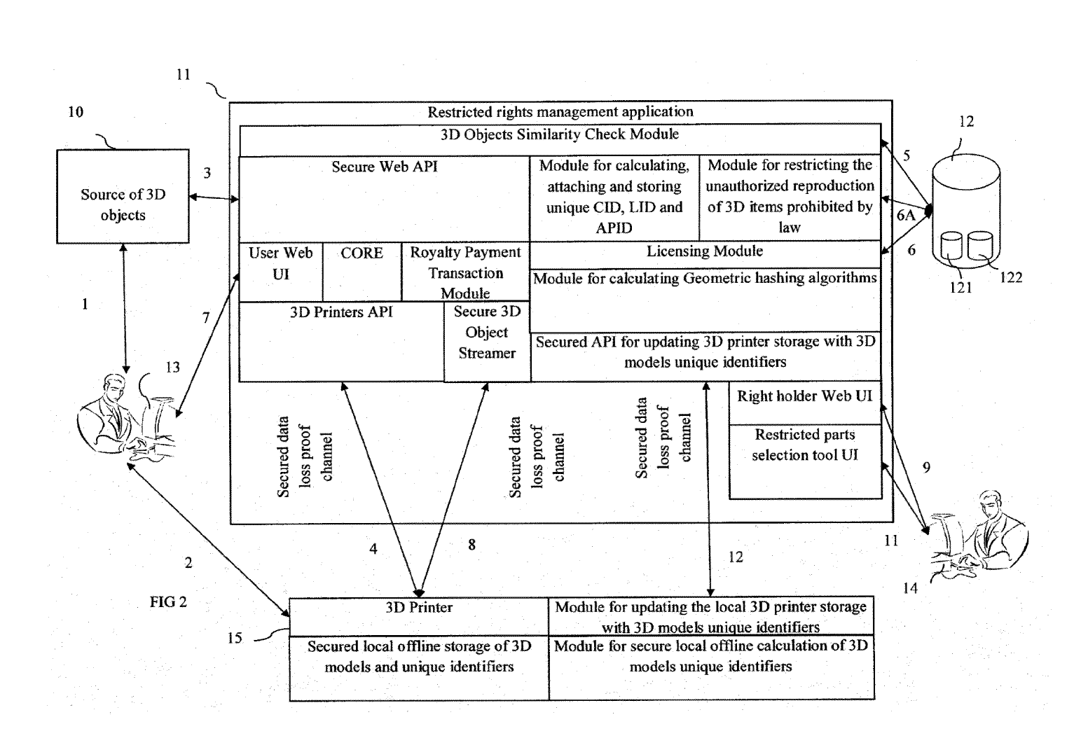

In accordance with another embodiment of invention, a more elaborated system of FIG. 1 for enforcing 3D restricted rights in a rapid manufacturing and prototyping environment is shown in FIG. 2. The same reference numbers are used as in FIG. 1. The skilled person appreciates that the teaching of the embodiments of FIG. 1 and FIG. 2 can be freely combined with each other. The system comprises a source of 3D objects 10 as in FIG. 1. The end-user can access the source of 3D objects 10 over the Internet or LAN using the end-user device 13. The restricted rights RR management application 11 may include a 3D objects Similarity Check Module, a Web Application Interface (Web API; for checking the licenses/copyright/anti-piracy or other restricted rights permissions status and authorizing of 3D print requests from 3D online services and communities) for receiving IPR related inquiries from the source of 3D objects 10, a web based user interface (User Web UI), 3D printers API (for verifying, transferring and granting licenses to parts of or to complete 3D models) for communicating with 3D printer 15, checking every 3D model to be printed against objects in RR database 12, Licensing Module for providing the user with necessary license for reproducing the 3D object, a Royalty Payment Transaction Module allowing the user to pay any license fees required, a 3D Object streamer for streaming of 3D object data through Internet or LAN directly to the 3D printer 15, a module for calculating, attaching and storing unique identification code (such as copyright identifier CID, license identifier LID, anti-piracy identifier APID, etc), a secured API for updating 3D printer storage with 3D models unique identifiers, Module for calculating geometric hashing algorithms, Module for restricting the unauthorized reproduction of 3D items prohibited by law, and a core for operating the RR management application. The RR management application also has a rights holder Web user interface so that the rights holder can upload new 3D objects into RR database and modify rights and permissions associated with such 3D objects using rights holder device 14. The RR management application has a restricted parts selection tool UI allowing the rights holder to indicate the parts of the 3D object which use is restricted or prohibited.

3D Printer as shown in FIG. 2 may include a secured local offline storage of 3D models and unique identifiers, a module for updating the local 3D printer storage with 3D models unique identifiers and a Module for secure local offline calculation of 3D models unique identifiers.

The system as shown in FIG. 2 is operated similarly to system on FIG. 1. The user is requesting a 3D object from a source of 3D objects (step 1) to be reproduced using 3D printer 15 (step 2). The source of 3D objects sends an inquiry to the RR management application through the Secure WebAPI (step 3). The 3D printer 15 has a software code or a hardware device installed that requires for every 3D model to be printed with a confirmation, through a 3D printers API from the RR management application that reproducing of the 3D model is not restricted (step 4). The restricted rights management application checks if restrictions exist in RR database (step 5). The Licensing Module is initiated (step 6), and the end-user is offered a license, or the Module for restricting the unauthorized reproduction of 3D items prohibited by, law is initiated (step 6A), if the 3D object is prohibited from reproduction. The Licensing Module may be adapted to provide any type of license, including single, multiple or other types of licenses for reproducing authorized restricted rights 3D models. The end-user can communicate with the RR management application through the user Web UI (step 7). If the license terms include royalty payments, the Royalty Payment Transaction Module is initiated and the end-user is provided with opportunity to pay for the license. Then, the 3D printer 15 is provided with a confirmation that the 3D model can be printed, and the 3D model is delivered (sent, streamed) to the 3D printer 15 through 3D Object streamer (step 8).

The 3D printer 15 is adapted for offline storing of 3D models and their unique identifiers in a storage. The storage is updated while the 3D printer is connected to the network (step 12), and the unique identifiers are calculated in the 3D printer or updated from the network.

The system allows the rights holder to update the RR database to upload new 3D objects together with their restriction terms (step 9), including determining which parts of the 3D object are restricted from reproduction using Restricted parts selection tool UI (step 11).

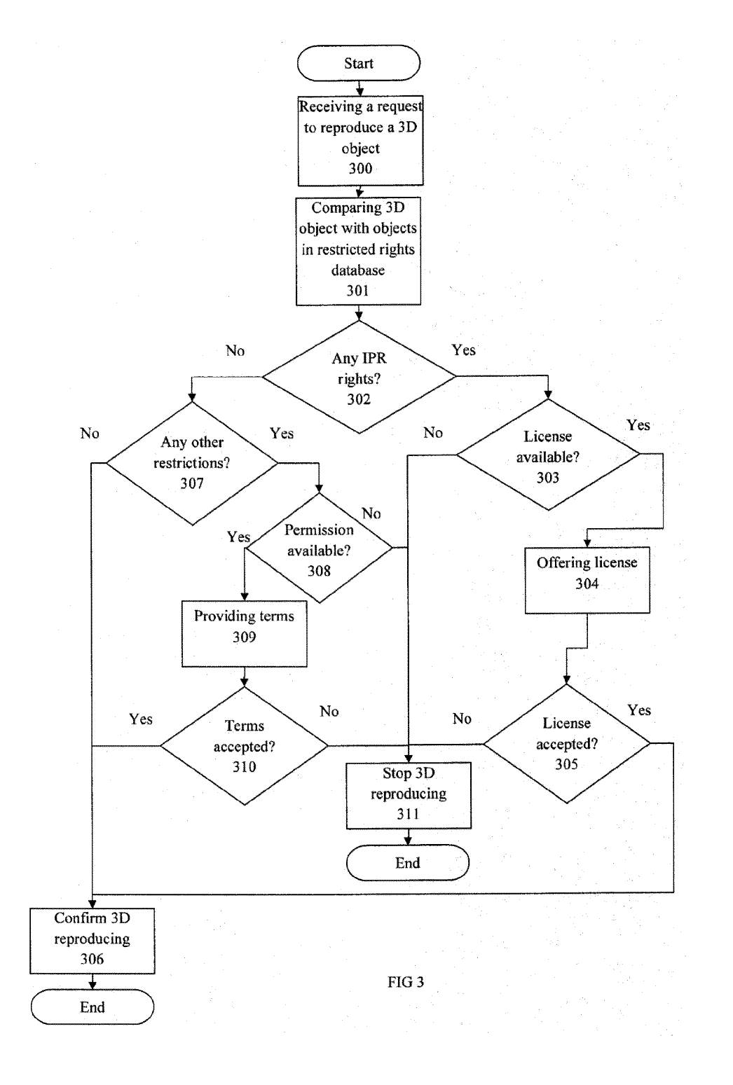

A method of enforcing 3D restricted rights in a rapid manufacturing and prototyping environment according to one embodiment of the invention is depicted in FIG. 3. The method may include receiving by a computer system a request to copy (i.e., to reproduce, to make a mechanical 3D copy) of a 3D object (step 300) or of at least one part of said 3D object; determining by the computer system whether any restrictions exists for mechanical reproduction of the 3D object by comparing the 3D object with objects in a restricted rights database (step 301). First, it is checked if any IPR right exists (step 302). If yes, a determination may be made if a license is available (step 303). If not, the 3D reproducing is stopped or blocked by the computer system. If yes, the user is offered a license to make a 3D reproduction of the 3D object (step 304). If the license is accepted (this may include paying for the license, if the license is not for free) (step 305), the 3D reproducing request is confirmed (step 306). This may include providing the reproducing device, the 3D object itself or the user with a unique ID enabling making one or more reproductions. If the license is not accepted, the 3D reproducing is stopped or blocked (step 311). Other affirmative actions can be taken by the system as described below.

If no IPR's exist, other restrictions are checked (step 307), such as restrictions to make copies of prohibited items such as weapons and firearms and their parts, or restrictions based on other rights such as personality rights, rights to personal image (likeness), or restrictions based on a contract (e.g., access agreement terms to use commercial 3D image databanks). If yes, it is checked if permission is available (step 308). If not, the 3D reproducing is stopped or blocked. If yes, the end-user is provided with the terms of such permission (step 309). If the terms are accepted by the end-user (this may also include paying fees for making 3D reproductions) (step 310), the 3D reproducing request is confirmed (step 306). If the terms are not accepted, the 3D reproducing is stopped or blocked (step 311).

The determining if any restrictions exist in a restricted rights database can be accomplished by comparing the 3D object, the electronic file of the 3D object, or an identification code stored directly in the 3D object or attached to the electronic file of the 3D object, with corresponding records in the 3D restricted rights database.

The computer system may take an appropriate affirmative action based on the restrictions. Such affirmative action may be one or more actions, including (i) sending a notice to the end-user that the 3D object is protected by intellectual property rights, (ii) sending a warning to the user that reproduction of the 3D object is illegal, prohibited, or restricted, (iv) stopping the tools from reproducing the 3D object, (iii) stopping the computer system from copying, alternating, removing, moving or streaming of the 3D object and its electronic file, providing the reproduced 3D object with labeling that it is an unauthorized copy, is for private use only, or other information of similar nature, and (v) altering the reproduced 3D object to make it safe or unusable for prohibited purposes, or offering the user a license for fee or for free.

Offering the user a license to reproduce the 3D object, receiving the user's acceptance of the offer and delivering (sending, streaming) the 3D object to a rapid manufacturing or prototyping tool over a secure and data loss proof channel. Such method may include receiving a payment from the user by any known means, including but not limited to using credit or debit card payments, using prepayment account, using gift cards or vouchers, making a wire transfer using Internet banking, or using electronic payment services such as PayPal, etc.

As previously described, one embodiment of the 3D reproduction process may be controlled by providing the end-user the electronic file, the rapid manufacturing, or the rapid prototyping tool with a unique identification code necessary for reproducing the 3D object. Alternative processes may be utilized in accordance with the principles of the present invention as provided further herein.

Several use cases of the systems and methods according to present invention are now discussed.

Use case 1: The Rights Holder

A rights holder of any restricted rights, including intellectual property rights, such as copyright, design right, 3D trademark right, design patent or utility patent rights, personality rights, or other rights, opens an account with the service. The rights holder agrees to its terms. Using the rights service, accounts can be for fee or for free. The rights holder can be asked to fill in payment options and details. There can be several security and authentication alternatives available to make sure that the rights holder has the right to register the designs as well as for future authentication of returning rights holders.

In one embodiment, rights holder can open a modifiable storefront in the service. This storefront user interface can be branded to reflect the rights holders wishes, brands and requirements and for display to visiting customers of the service.

The rights holder may upload a 3D model into the service and indicate the parts of the 3D object or the whole 3D object that rights holder wants to protect by limiting its 3D copying. Any licenses can be revoked or canceled any time, due to misuse or other reasons.

The rights holder may select the desired protection or restrictions level. For example, the rights holder may choose to allow free and unlimited distribution of the 3D model (but, e.g., requiring that attribution rights are respected) or to charge a license fee for parts or the whole 3D object or their combinations.

The service may calculate and categorize the 3D objects based on their shape, color, pattern and selected other properties that the rights holder wants to protect or their combinations. The identification data is stored into the restricted rights database.

The service algorithms are used to filter out basic forms, shapes, patterns, etc., and other objects that cannot be protected, such as a simple square or round object. These can be either preloaded into the service by the service administrator or can be updated, e.g., by the rights holders.

Service algorithms can be used to limit submission of unauthorized claims for already uploaded and protected 3D objects by other service users so that basic forms and objects of other rights holders cannot be claimed by unauthorized service users. In case of conflict, the service can present options to the service users or rights holder to resolve the conflict and alter the option selections until the submission is approved. A dispute resolution option may be provided. Once there is no conflict, the 3D object is approved for upload and storage in the restricted rights database.

There can be a community feedback tool for the rights holders and other service users to vote, rate and give feedback on the uploaded 3D objects. This feedback can be about the quality of the design, model and their printability or objections to the originality of the design or model that has been uploaded and protected. There can be an elimination process based on enough negative feedback of the protection or restrictions of the whole model or parts of it In the case of crowd sourced community projects or other common creation designs, the 3D models and designs can be attributed to several rights holders and royalties and revenues can be attributed to more than one rights holder.

The service user interface tool allows sharing the submissions during submission process with other rights holders and service users for input, either live during submission process or through accessing the submission 3D model from their own user accounts later, modify the submission and save it.

The submitting rights holder (e.g., a 3D model store owner in the service) can change roles and give the submission role to another rights holder or service user at any stage. The service saves and keeps track of these changes. There can be multiple rights holders and other users registered as the authorized submission/administration role.

Use Case 2: 3D Models Online Shopping Site Customer

3D online shopping site customer or user is a person using the service from a third-party or service's own shopping web service, community, or application for 3D objects.

The visitor of such websites and services can use features of the service as a registered or unregistered user. If the user registers as a user of a third-party service, the process depends on their rules and terms.

If these third party shopping sites use the system according to the principles of the present invention, their services are connected to it through the network using the APIs.

If the user accesses the service from a computer (or other device), the service can collect identifying information about the device, such as location and IDs, including the 3D printer ID if one is detected. If there is no 3D printer ID detected, the 3D printer is provided with the ID by the system. If the ID of a 3D printer is not automatically detected and sent to the service, the service can provide a unique ID to the 3D printer for IPR purposes and store the unique ID. If the user computer is connected to a 3D printer or the 3D printer is connected directly to the network, the 3D printer ID is registered into the service databases for future verification purposes through the network. This ID can be used as an additional method for verifying authorization to reproduce objects through that 3D printer.

3D Object reproducing licenses can be tied with printer IDs to have the option to restrict further the printability on certain printers.

When a user is visiting a third-party online service or community for printable objects, the user may be presented with a range of objects to review and purchase. The service may learn from these visits, habits, and purchases and may suggest options based on these as well. The 3D printer ID can be used to help improve these results.

The user selects one or more objects for 3D reproduction. The user is presented with the payment options and completes payment. This can happen inside the service, in an external service or through online payment brokers. In the case of a user visiting a 3D print shop and requesting to print the object there or sending the object to such a service, these steps may be performed by the administrator of the service.

Reproduction rights can be verified in different stages:

A third-party service can allow the service to check their uploaded 3D objects for restrictions during their upload by users of the third-party service and/or the restrictions may be checked every time the 3D object is reproduced. The 3D objects may be verified at least each time they are reproduced by the 3D printer.

Open Source 3D printers can be restricted, controlled, and verified by attributing IDs to them or checking the 3D printer ID against stored IDs in service database as an effort to control also open source printers when they are connected to the networks, such as the Internet, and are trying to reproduce any 3D object.

If the user is allowed to buy and download a full 3D model via the network, a user can download the full 3D model to the local computer or device.

Before reproducing, the 3D printer and/or the computer sends the 3D model to the service where it is compared, in whole or in part, to the 3D models stored in a restricted rights database and restrictions.

In one embodiment, the service can also divide the 3D models into smaller portions using different methods and send these portions to the service where they are checked against the database. In this case, a full 3D model does not have to be sent to the service for comparison.

If there is no match found that restricts reproducing in any way, a permission to print it locally is returned from the service and presented to the user. Alternatively, in such case no information is presented to the user and reproducing can proceed automatically.

If there is a match found in the service and database the user can be offered a license to reproduce it. These licenses, their cost, duration, validity, etc., can vary depending on the rights holders or service provider terms.

If the third-party or the service uses 3D model streaming over a secure data loss proof channel, the 3D model is checked in the service before it is streamed to the user for reproduction so that unauthorized objects are not streamed. Alternatively, a routing comparison method is used where the streamed data are compared live during streaming in the service against the models in the database by routing the stream via the service before or during the reproduction. When restricted rights are found, the streaming can be stopped or blocked.

The service can check during the streaming that the process is successful and not modified in any way in breach of the terms of the license.

Use Case 3: User Own Offline Creation

In this case, the user is not connected to the Internet, to the service, and/or the restricted rights database. The user creates a 3D model using a computer or other device, software, through modifying an existing model, or by a scanning the 3D object with a 3D scanner.

The 3D printer can be equipped with software and/or hardware (storage) that locally stores and updates a library/list/collection of objects that are restricted for any reason from reproducing (3D reproducing). These locally stored objects can be but are not necessarily full models. The locally stored objects can be calculations of their originals for restriction verification purposes.

If the 3D printer is offline from the network, the 3D printer will only allow reproducing objects that are not recognized as restricted in the local storage. If there is a match against the stored models, it is not possible to print the object before reconnecting to a network and updating the storage and possibly purchasing a license for it if there is still a match and availability online.

A maximum temporal or numerical limit until which the 3D printer can be allowed to be offline and not updated may be set. If this time or printed objects number limit is exceeded, the printer may be configured to not print more objects before updating it again. Such a restricted configuration is to prevent or minimize making unauthorized 3D copies during extended offline use. The time limit or number of printed objects can vary depending on manufacturer, service or other reasons but cannot be changed or tampered with by unauthorized users (consumer, authority or business user).

Once the 3D printer has network access restored, the local storage is automatically updated. This process can not be modified by unauthorized users. These functions can be combined with the 3D printer ID to further improve accuracy of each printer protection updates. Service databases can keep track of each stored 3D printer and their attributes for IPR protection purposes and store their update history, their offline/online status, etc. The service can produce statistics of global 3D reproducing through these printers. Such result can be used to find out shopping habits, offer recommendations and advertising possibilities. The service can present prompts and reminders to the users when the 3D printer is due for updating as well as warnings about impending limitations due to missing updates.

Use Case 4: User Own Online Creation

In this case, the user is connected to the Internet or other computer network and to the service and its databases. The user can create a 3D model using a computer or other device, software, through modifying an existing model, or by scanning the 3D object with a 3D scanner. The 3D printer can check both locally and/or through the network connection to the service if the object or any part of it can be reproduced for free, for a license or cannot be reproduced at all, e.g., when the rights holder has completely restricted the reproducing or the item is a dangerous item, such as a weapon or parts of a weapon.

The 3D printer can be equipped with software and/or hardware (storage) that locally stores and updates a library of objects that are restricted for various reasons for reproducing. These locally stored objects can be but are not necessarily full models to prevent misuse. In one embodiment, the objects can be only calculations of their originals for copyright verification purposes.

If the object is not restricted, can be reproduced for free, or cannot be found in the database, the printer will print it without restrictions. There can be a message to be displayed to the user or not.

If the object is fully or partially licensed, the service will prompt the user to acquire a license to print the object. This license is offered to the user for free or for a fee. The user can be shown different payment options and guided through the payment in easy steps.

The user can accept or reject the license offer. In the case of accepting the license offer, the user will complete the purchase process. If the user rejects the license offer, the reproducing is not possible for items that require the license.

When the license is granted (and paid if not free), the service will start delivering (sending or streaming) the 3D model to the 3D printer of the user, and verifies that the 3D model is fully printed. In the case of quality issues, the user can reprint the object, e.g., when the printer runs out of reproducing material or has network problems. The user has a feedback channel to issue a quality claim in case of problems with the service.

The licenses can be acquired for reproducing single or multiple items. There can be a time limit within which the object must be printed or all the licenses be used. Licenses can be also tied to a particular printer ID and restricted per printer ID in which case the object can only be printed in that particular printer. For other printers, a new license is required—this can depend on the license selection the rights holder chooses or can be part of the service by default.

3D model streaming to the 3D printer happens using either standard or proprietary protocols, formats and methods. Interrupted (for example, network connection problems) can be avoided by buffering the model stream to the printer or the computer.

The service completely prohibits the print or manufacture of parts of fully restricted items, such as guns. These restricted items can be uploaded into the service by authorities, for example. There can be a message displayed to the user that certain items are not allowed to print with or without a license or permission.

These functions can be combined to the 3D printer ID to further improve accuracy of each printer protection updates. The service databases may keep track of each stored 3D printer and their attributes for IPR purposes and stores their respective update history, their respective offline/online status, etc.

Use Case 5: 3D Scanner Case

The user has a 3D scanner, access to a 3D scanner, or orders an object to be 3D scanned in a service. The user selects a 3D object for scanning and scans the object using the 3D scanner. The 3D scanner is connected to the Internet and attaches a tag or tags to the scanned 3D object file with or without a software on the computer or scanner. In offline use, this tagging can happen via locally installed software and/or hardware device on the 3D scanner and/or computer. The user can attribute certain tags to the scanned objects such as shape, color or pattern descriptors or choose to have the service to do this automatically.

Certain tags can already identify the object as registered, or IPR protected, for example, if scanning a known protected object, or categorize it based on its features, shapes, patterns for recognition then or later in the service database. These tags can include such as shape (“round”, “square”, etc.), taxonomy (“mouse”, “bird”, etc.), color (“red”, etc.) or any other type of tags redeemed necessary or their combinations. These tags can be hashes or encrypted etc. and not visible to the user.

Certain tags that are for identifying IPRs are not user modifiable and accessible, they are created automatically and are tamper proof. Tag modification can be allowed for certain administrators. Scanners with IDs can be identified when connected to the network or a computer/network and store the IDs for IPR protection and restriction enforcement purposes.

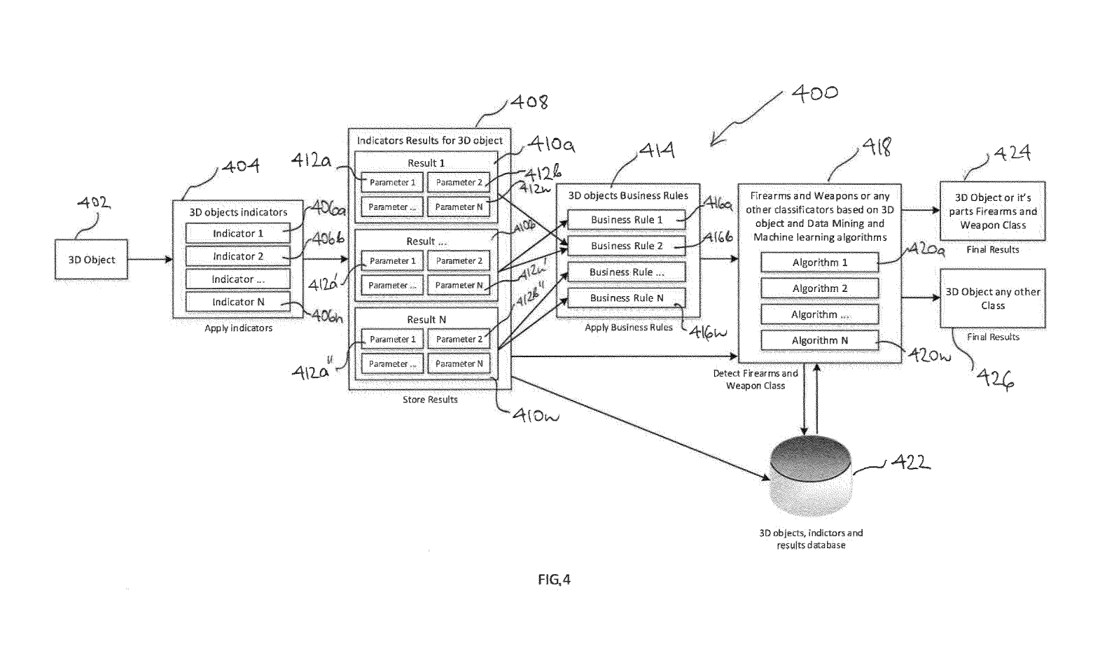

With regard to FIG. 4, a block diagram of an illustrative process 400 for processing 3D objects to determine whether the 3D objects or a portion thereof are original and/or have restricted rights associated therewith is shown. This process could be also called a Design Originality Recognition (DOR). During this process computer system is able to analyze, store and compare 3D objects for copyright recognition and licensing purposes in 3D printing and manufacturing. The illustrative process 400 is shown to include a 3D object 402 to be presented to the process 400 for indicators to be applied thereto. 3D object 402 may be presented as a stereolithographic (STL) file or other format 3D file, as understood in the art. The STL file may include a list of facets of a 3D object to be 3D printed or otherwise manufactured. Each facet may be uniquely identified by a unit normal (i.e., a line perpendicular to a triangle that at least in part defines a facet and has a length of 1.0) and three vertices (i.e., corners of the triangle). The 3D object 402 may be submitted to a 3D object indicators module 404 inclusive of one or more indicators 406a-406n (collectively 406). The indicators 406 are functions that receive an input of the 3D object 402 in any 3D file format (e.g., STL, OBJ, etc.). More specifically, the indicators 406 may be any kind of function that characterizes the 3D object 402 based on its representation in the 3D file.

Indicators results 408 for the 3D object 402 include results 410a-410n (collectively 410) from respective indicators. Each of the indicators 406 outputs one or more parameters 412a-412n (collectively 412) that characterize a given 3D object from a certain perspective. Note that each of the results 410 of the respective indicators 406 have parameters (e.g., parameters 412a′-412n′ (collectively 412′), parameters 412a″-412n″ (collectively 412″)) that may be the same or different from those of other indicators. If the indicators 406 are all different from one another, then it would be expected that some or all of the parameters 412, 412′, and 412″ resulting from the different indicators 406 would be different by virtue of the functions producing different parameters. Indicators can return similar or the same results regardless of 3D model or 3D object shape and representation (plain object, molds for the object, parts of the object, etc.) For example, it is possible to have 3D models of a gun, and print a gun, however it is also possible to have a 3D model of a mold, which could be used to create the same gun. It is also possible to have separate 3D models, which in case of printed, could be put together to build a gun, or there could be different parts of mold or molds, which after printing and combining could be used to produce the same gun. In all these cases, indicators will give very similar results, so that based on the resulting parameters it is possible to distinguish visually or by the usage of data mining and machine learning algorithms that all 3D object representations actually represent one and the same or very similar object, in this particular example a gun.

One example of an indicator is a function that calculates a number of vertices of which a 3D object includes. In such an example, a single parameter for the number of vertices exists, where a result for that parameter is a single value (e.g., 3478 vertices). Other more complex functions for the indicators 406 may be used, including center of mass, corpus indicator, detail indicator, comparison of angles, nearest points, number of points, number of edges, number of facets, different types of skeletons, object geometric representation, average deviation of points, bounding corners density, and corresponding parameters all these possible functions return, for example: graphs, vectors, objects, JavaScript Object Notation (JSON), and so forth. These indicators 406 may help the process 400 solve a problem of comparing a subcomponent or whole of a 3D object 402 that is being processed prior to printing or manufacturing in accordance with the principles of the present invention.

Continuing with FIG. 4, a 3D objects business rules module 414 may include one or more business rules 416a-416n (collectively 416). The business rules 416 are rules that check the parameters 412 and make a decision based on the parameters 412. Business rule may be any rule which describes which states one or set of returned indicator functions parameters should take in order to distinguish one model from another or one class of objects from another. Examples of business rules are: check for tubes in the model, based on indicators, if there is a subshape like tube, with hole diameter between 4 mm and 50 mm, then set has_gun_tube parameter to 1; check for rifling inside the tube, if it has it set has_gun_rifling_tube parameter to 1. The parameters may have values of 0 and 1, or may also include a probability coefficient, for example 0.68. Business rules could be simple if-then-else clauses, or more complicated data mining and machine learning algorithms which, based on the indicators values, detect whether a particular object is e.g., a firearm or weapon, detect the type of the object, or, e.g., of an animal, etc.

The decisions made by the business rules 416 may be generated in a coded way so that it is possible to process the decisions using a classificator module 418 with data mining algorithms 420a-420n (collectively 420). The classificator module 418 is illustrative for use in identifying a portion of or a complete firearm or weapon, and the data mining algorithms 420 support the classificator module 418 in that regard. It should be understood that the classificator module 418 may be configured to identify any other object, including objects that are protected by intellectual property rights (e.g., copyright) or otherwise.

An example list of business rules may include (i) loading techniques, (ii) magazine types (e.g., internal, detachable, belt-fed, etc.), (iii) firing mechanisms (match-lock, wheel-lock, flint-lock, percussion cap, etc.). Other business rules that may be used to check the parameters 412 for other weapons (or non-weapons) may additionally and/or alternatively be utilized in accordance with the principles of the present invention. The business rules 416 may be configured as simple if-then-else clauses or more complicated data mining and machine learning algorithms which, based on the values of the indicators, detect whether a particular object is a firearm, weapon, or neither, and, if so, which type is it. Makes and models of firearms and weapons may additionally be determined if sufficient parameters are available to the business rules 416. One of the implications of this method is voting data mining and machine learning algorithms, as understood in the art, for firearms and weapons detection from 3D files. In voting, one or more portions of a 3D model may be voted on by a computing unit, which may be formed of one or more computing devices locally or remotely positioned and in communication with one another, as to whether the one or more portions of the 3D model match a rights restricted 3D model. In determining whether a match exists, matching may be performed using logical and/or mathematical algorithms as described herein.

As an example of an algorithm, if 3D object has more than 1 million vertexes, then a determination may be made that the 3D model is, for example, a model of animal or a human. Of course, the decision may be performed based on results of many indicators and associated business rules using machine learning and data-mining classification and prediction algorithms. For the algorithms 420 that are configured to identify a firearm or weapon, the algorithms may determine whether the 3D object 402 is representative of a component or an entire firearm (e.g., trigger) or weapon (e.g., detonator) by comparing a number of vertexes, number of facets, angles of the facets relative to one another, and so forth that define the 3D object.

The classificator module 418 may include known algorithms that are publicly available or proprietary algorithms. Such algorithms may utilize linear regression, time series, Naïve Bayes (learner and predictor), fuzzy rules (learner and predictor), multi-layer perceptron (MLP) neural networks, probabilistic neural networks (PNN), such as k-nearest neighbor (k-NN), decision trees (learner and predictor), boosting (learner and predictor), association rule (learner and predictor), support vector machines (SVM), and so forth.

As further shown, a database 422 may include data that is supportive information on predicting whether the 3D object 402 is a firearm or weapon. Data may be supplied to the database 422 from the indicators results 408 and supplied to and accessed by the classificator module 418. The database 422 may utilize any data repository configuration and protocol, such as a relational database, as understood in the art. In one embodiment, the database 422 stores sets of parameters that are representative of results from 3D object indicators, such as 3D object indicators 404. The sets of parameters may be used for comparison purposes by the algorithms 420 to determine or approximate what, if any, component or whole firearm or weapon is being represented by the 3D object 402. While shown with a database 422, it should be understood that the principles of the present invention may be independent of a database. Final results 424 may be produced from the algorithms 420 to identify the 3D object or its parts to be identified as a firearm, weapon, or component thereof. Again, final results 426 identifying 3D objects other than firearms or weapons, such as 3D objects that are being protected by intellectual property rights, may be identified using different indicators 406 that produce different parameters, different business rules 416, and/or different algorithms 420.

In the event that the restricted rights process 400 is operating within a 3D printer or other manufacturing equipment, in the event that the final results 424 determine that a 3D object has rights that are being protected, as previously described, the 3D printer or other manufacturing equipment may be prevented from printing (or caused to be prevented from printing from a remote computing device, such as an IPR database). In addition, a notification may be made to a manager of the protected rights and/or governmental authorities along with location (if GPS or network address enabled) and other user information if available via a network communication (e.g., email, SMS message, or other electronic message).

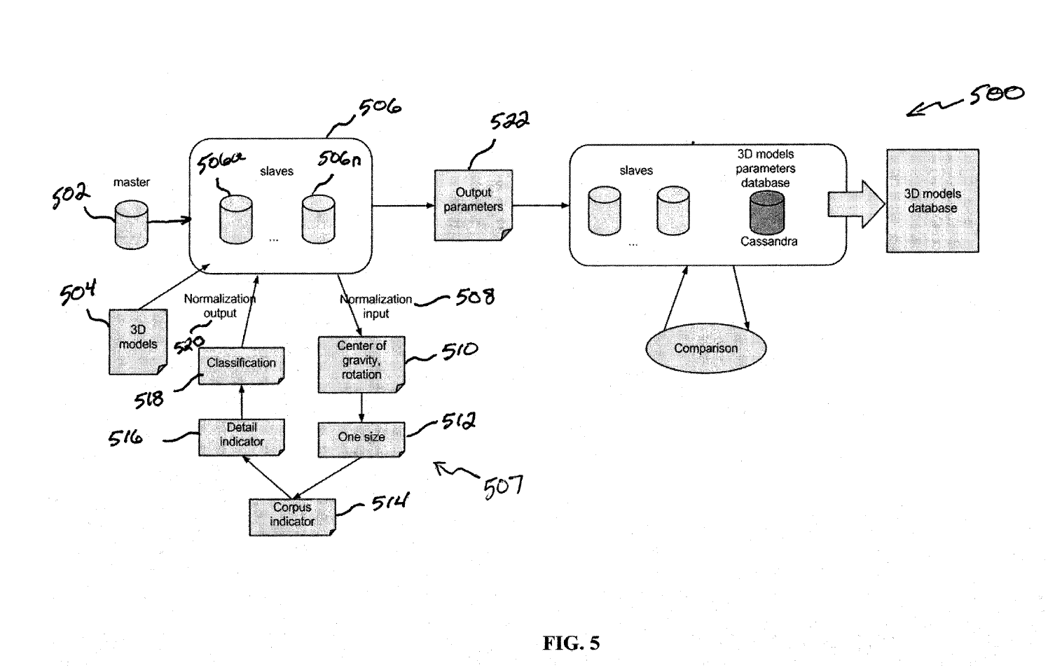

With regard to FIG. 5, a block diagram of an illustrative architecture 500 for determining design originality and/or restricted rights status of a 3D object is shown. The architecture 500 may include a master database 502 that may receive 3D models 504. Alternatively, the 3D models 504 may be submitted directly to slave databases 506a-506n (collectively 506) via a communications network (not shown), such as the Internet. As understood in the art, the slave databases 506 may be positioned in the “cloud,” thereby enabling the master database 502 to submit job requests to the slave databases 506 utilizing a cloud computing protocol, as understood in the art. The master database 502 and slave databases 506 may be integrated or in communication with a computing system, such as a computer server, that may be configured to perform both data processing (e.g., performing 3D indicator processing) and database management operations.

A subprocess 507 that may be performed by the slave databases 506 (or computing systems associated therewith) to perform normalization on the 3D models 504. The subprocess 507, in this embodiment, is used to generalize or otherwise produce a less detailed representation of a 3D object. The normalization, as provided further below, is capable of adjusting the 3D model (or altering a copy of the 3D model to preserve the integrity of the original model) so that size, orientation, and other parameters may be similarly sized and oriented with other 3D models and/or objects, for example, 3D object could be moved to the beginning of coordinates (x=0, y=0, z=0). Normalization also for example can include resolving errors in CAD file and treating surface errors. As shown, a normalization input 508, which is a 3D object in an STL or other datafile configured to store a 3D object, may be submitted to a function 510 to compute center of gravity and/or rotate the 3D object. The function 510 may compute the center of gravity of a 3D object to produce a parameter that may thereafter be compared with other 3D objects. In one embodiment, the 3D object may be rotated (or a value indicative of the rotation to align the 3D object to a normal position may be computed). By rotating or calculating a rotation value as a parameter, a more direct comparison can be made between two 3D objects.

A function 512 may be used to resize the 3D object (i.e., the normalization input 508). Because datafiles used to store 3D objects may have different scales, resizing the 3D object to be “one size” may better enable two different 3D objects to be compared. In one embodiment, standard dimensions in which the 3D object may be fit may be utilized. In one embodiment, the standard dimensions may be different depending on a variety of factors, such as scale, complexity, type of 3D object, and so on. As an example, vehicles may be sized to standard dimensions in which automobiles typically are scaled, while semiconductor devices may be scaled for standard dimensions in which semiconductor devices are typically scaled.

Function 514 may be configured to generate a corpus indicator, where the corpus indicator may be considered a box that is used to fit the 3D object. The corpus indicator may use the standard dimensions used by function 512. It should be understood that having the standard dimensions identical for each 3D object, or at least each similar type of 3D object, may be helpful for comparison purposes, but that differences between size and scaling may be possible for performing comparisons between 3D objects in accordance with the principles of the present invention.

Function 516 may be a detail indicator configured to set normals of 3D objects to be aligned. For example, a 3D object that is an automobile may have a normal extending from a roof of the automobile, and 3D objects of automobiles may be processed by the detail indicator to cause the normals to extend from a roof of the automobiles and oriented in the same direction (e.g., pointing up at zero degrees). The detail indicator may be a parameter representative of the orientation adjustment needed to have a normal of the 3D object positioned aligned with other normals of 3D objects. By orienting the normals of 3D objects, easier comparisons can be made between 3D objects.

Function 518 may be configured to classify one or more parameters of the 3D object or components thereof. The classes may be assigned predetermined classes (e.g., class 1, 2, . . . , n; class A, B, . . . N) to the 3D object. The classes may reflect similarity of parameters between the 3D object or components thereof that may be used for data mining or comparison purposes. A normalization output 520 include parameters that represent the generalized 3D object. The normalization output 520 may be coded in a manner that can provide for data mining and/or searching to determine whether the normalized 3D object matches another 3D object or portion thereof.

Output parameters 522 may include the parameters generated by the various functions in the subprocess 507 used to normalize 3D objects. The output parameters 522 may be saved to the slave databases 506. In one embodiment, a 3D models parameter database 524 may be configured to store the output parameters 522 of the 3D models 504. The database 524 may further be configured to store 3D models that have restricted rights, such as intellectual property rights and/or are restricted due to being firearms, weapons, ammunition, etc. The slave databases 506 are in the cloud and may include several, hundreds, or thousands of computers configured to process the 3D model data. As shown, the comparison process 400 of FIG. 4 allows for comparison of the 3D objects with the restricted rights 3D objects, as previously described. The 3D models 504 and/or output parameters of the 3D models 504 (and/or 3D objects) may be communicated and stored in a 3D models database 526 for further usage.

With regard to FIG. 6, an illustration of an illustrative triangular facet 600 that may be used in determining originality and/or restricted rights of a 3D object is shown. The facet 600 may be used to define indicators, where each of the three vertices 602a-602c and normal 604 may be defined by three coordinates (e.g., x, y, z coordinates). The indicators, which may be a set of coordinates for the facet, may thereafter be used for determining originality and/or restricted rights of a 3D object by comparing the indicators with indicators of another 3D object. The facet 600 is an STL format facet specification that provides for direction of the normal to the facet. The normal vector is calculated mathematically, and provided as a parameter for the facet along with parameters of the vertexes of the facet that may thereafter be used for comparison purposes. In particular, the orientation of a facet is determined by the direction of the unit normal and the order in which the vertices are listed.

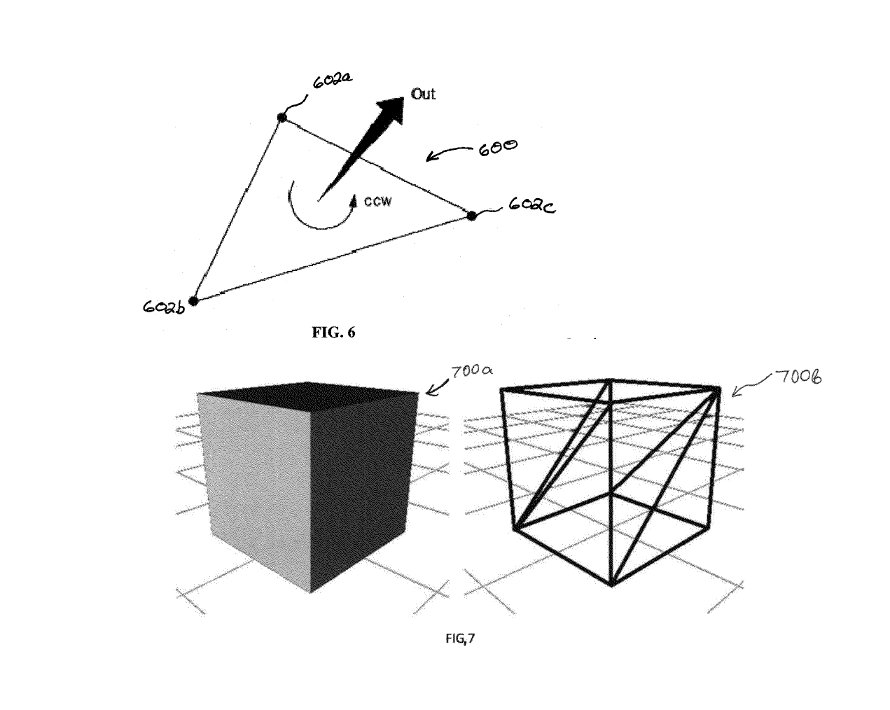

With regard to FIG. 7, an illustration of an illustrative 3D object as a solid (cube) 700a and as a wireframe 3D object 700b represented with triangular facets defining the skeleton of the solid 3D object 700a is shown. Simplified object skeleton is a set of vertices where each vertex is connected to at least one other vertex. The skeleton can be represented as a graph that is why skeleton comparison is reduced to comparison of graphs. It is noted that vertices pairs are the same as well as the length of links between them. The first problem can be solved by checking isomorphism of the graphs that is true only when “any two vertices u and v of G are adjacent in G if and only if f(u) and f(v) are adjacent in H”. In addition to isomorphism, lengths of the links are to be compared. This comparison can be done by checking whether two same vertices have link of the same size (in case objects have different scale this can be done proportionally). The triangular facets may be created using any facet generator, as understood in the art. Although the application provides for the use of triangles, the principles of the present invention may utilize any geometric shape to fit within surfaces or bodies of a 3D object. Conventional 3D model comparison algorithms are limited to comparing only ASCII STL 3D models. As understood in the art, ASCII STL 3D models are limited to a lot of triangles. These triangles form a model, for example, such as a cube, as provided in the wireframe 3D object 700b. The principles of the present invention, however, may use an algorithm that compares vertices or vertexes of triangles of one model with the vertices of triangles with another model. As triangles could be in different orders for the same model, the principles of the present invention use the vertices of sub-figures (e.g., triangles) and represent them as vertices of a 3D model. Such technique provides the ability to compare models by their vertices on the plane and pack them. Instead of comparing all vertices for cube, the vertexes are packed to main points. All these points are seen in the solid 3D object 700a.

In one embodiment, the process may read input STL files from first and second 3D models. The models may be into triangles or facets that define wireframes of the surfaces of the 3D models. Triangles may be compared for interconnected vertices recognition. Adjacent vertexes may be grouped into a list of points (e.g., x, y, z). The above steps may be repeated for another 3D model. The whole list of vertices of the first 3D model may be compared with the list of vertices of the second 3D model. Similarity of the two 3D models using the lists of vertices may be mathematically described as a percentage to show similarity of the two 3D models. For example, the a similarity value of 87% may mathematically describe similarity between two 3D models.

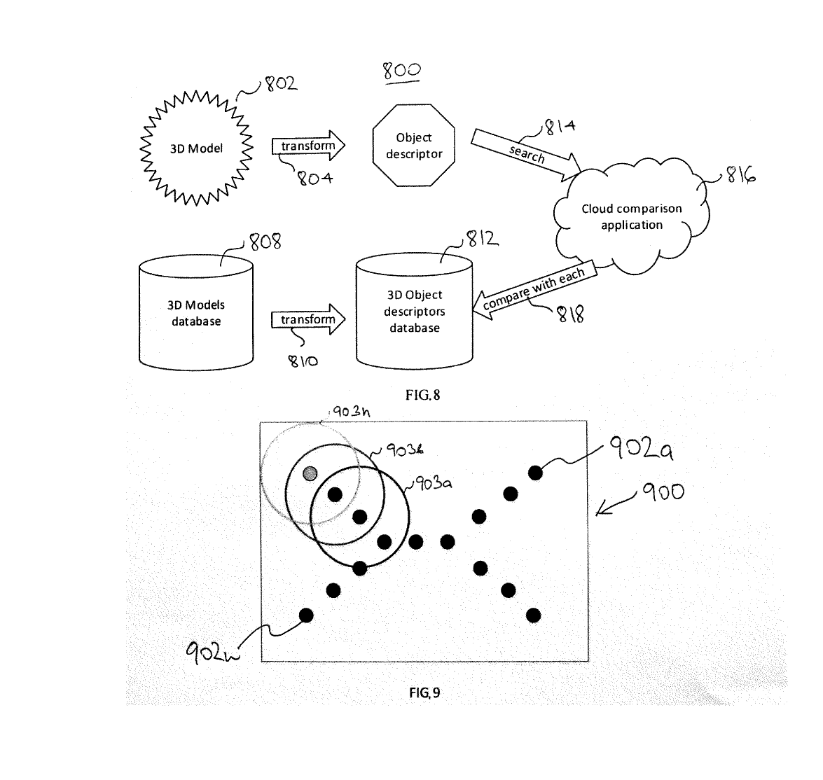

With regard to FIG. 8, a flow diagram of an illustrative system and corresponding process 800 for use in classifying 3D models is shown. In general, in order to compare two 3D models, descriptors may be used to classify each of the 3D models. The system may transform any kind of 3D model (i.e., described in any 3D file format) using common descriptors as other 3D models dynamically (i.e., on the fly) and compare the descriptors of a 3D model to be compared with existing descriptors of 3D model objects. Such complex processes may use “cloud” technologies, as understood in the art.

As shown, a 3D model 802 to be 3D printed is shown. The 3D model may be transformed using a transformation process 804 to produce an object descriptor 806 of the 3D model. The transformation process 804 may generate triangles that define surfaces, for example, to create a wireframe of the 3D model and 3D objects thereof. The object descriptor 806 is invariant to transformations, such as scale, rotation, mirror, and translation. A 3D models database 808 may be configured to store known and/or protected 3D models. The same or similar transform 810 as the transformation process 804 may be utilized to transform the 3D models being stored by the 3D models database 808 to produce 3D object descriptors for storage in a 3D object descriptors database 812. By using the same or similar transform 810 as the transformation process 804, an “apples-to-apples” comparison may be performed. It should be understood that transformation processes that are different from one another for speed or other purposes may be utilized in accordance with the principles of the present invention. For example, the transformation process 804 may be a faster transformation process and/or have less resolution than the transform 810 as the transformation process 804 may be performed in real-time and have to be consumer acceptable. If a determination is made that a probabilistic match is made between the 3D model and a 3D model stored in the 3D models database 808, then a more precise transformation may be utilized for the transformation process 804. The probabilistic match may, for example, be 80% or higher that the 3D object matches a 3D object in the 3D models database 808.

A search 814 may be performed via a cloud comparison or other application 816 to compare at 818 the object descriptor 806 with the 3D object descriptors generated from the 3D models being stored in the 3D models database 808. As understood in the art, the search may be utilized in data mining. The search may be responsive to a search query or be performed on a periodic or aperiodic basis to collect 3D model data based on parameters generated by the processes of FIGS. 4 and 5. As provided above, the comparison of the 3D model descriptors may result in a percentage of similarity the 3D model 802 or portion thereof and 3D model(s) in the 3D model database.

In one embodiment, an identifier, such as bracket, associated with the 3D model 802 that provides a basic type of object that the 3D model represents, so that the cloud comparison application can be limited to brackets as opposed to other devices, such as cups, housings, or otherwise. The identifier may for additional detail, such as bracket: server bracket: 4-post server bracket, thereby further narrowing the scope of the search. In one embodiment, a specified hierarchical listing of identifiers may be made available to allow for 3D models to be specified.

With regard to FIG. 9, an illustration of an illustrative object skeleton 900 for use in determining design originality and/or restricted rights status of a 3D object is shown. In a 2D format, the object skeleton 900 shows to be relatively simplistic, and real calculation happens with spheres in 3 dimensions. In this embodiment, the object skeleton 900 is configured as a focus of centers of maximal 3D balls 903a-903n (collectively 903) contained within a 3D object. That is, the centers 902a-902n of the maximal 3D balls 903 or volume pixels (“voxels”) are positioned at local centers of a path of a 3D object. A series of voxels form the object skeleton 900. That is, the object skeleton 900 may be formed out of smallest units of measurement. Alternative mathematical techniques for determining voxel position, such as using geometric mean along a path, may be utilized.

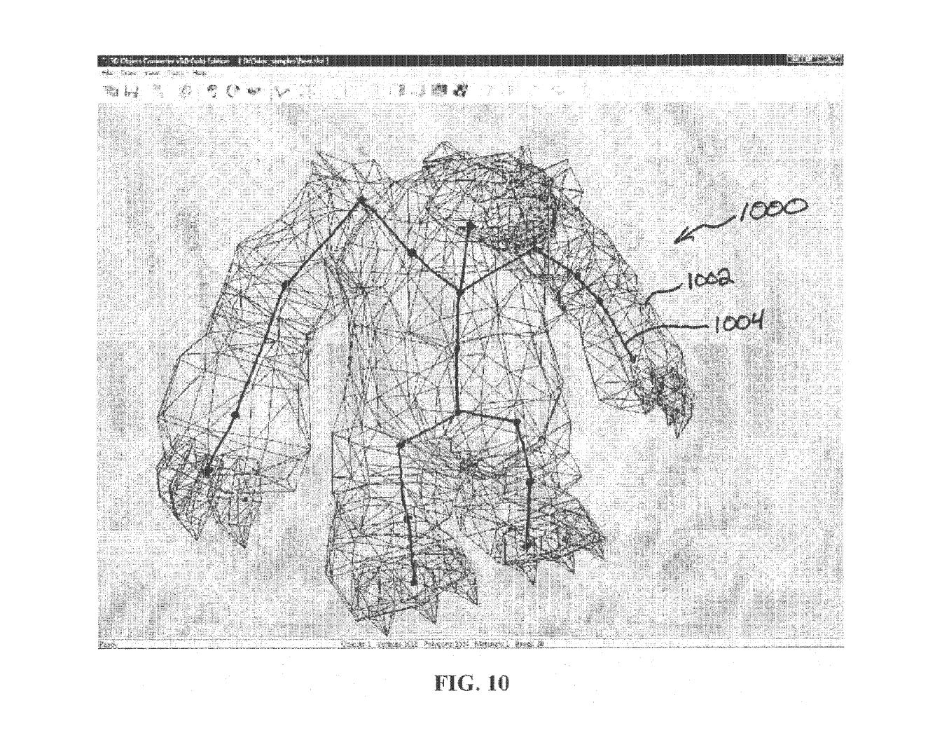

With regard to FIG. 10, an illustration of an illustrative 3D model 1000 represented by triangular facets 1002 for a surface of the 3D model 1000 is shown. Within the 3D model is a skeleton 1004 defined by voxels. This skeleton 1004 shows how even complex models can simplified by the use of a skeleton.

With regard to FIG. 11, an illustrative progressive detailization of a 3D object 1100, in this case a cow, for use in describing a 3D model is shown. A first skeleton 1102 may have little detail of the 3D object 1100. A second skeleton 1104 may have additional detail of the 3D object 1100. A third skeleton 1106 may provide more detail of the 3D object 1100. A fourth skeleton 1108 provides yet more detail of the 3D object 1100. A fifth skeleton 1110 adds even more detail of the 3D object 1100. These levels of detail may be generated through use of one or more 3D object indicators that produce results with different deal of parameters. The different levels of detail for each of the different skeletons 1102-1110 allows for business rules and algorithms (see, FIG. 4) to determine that the 3D model is an animal and, as the model detail increases to skeleton 1110, is a cow. As a result of the progressive detailization,

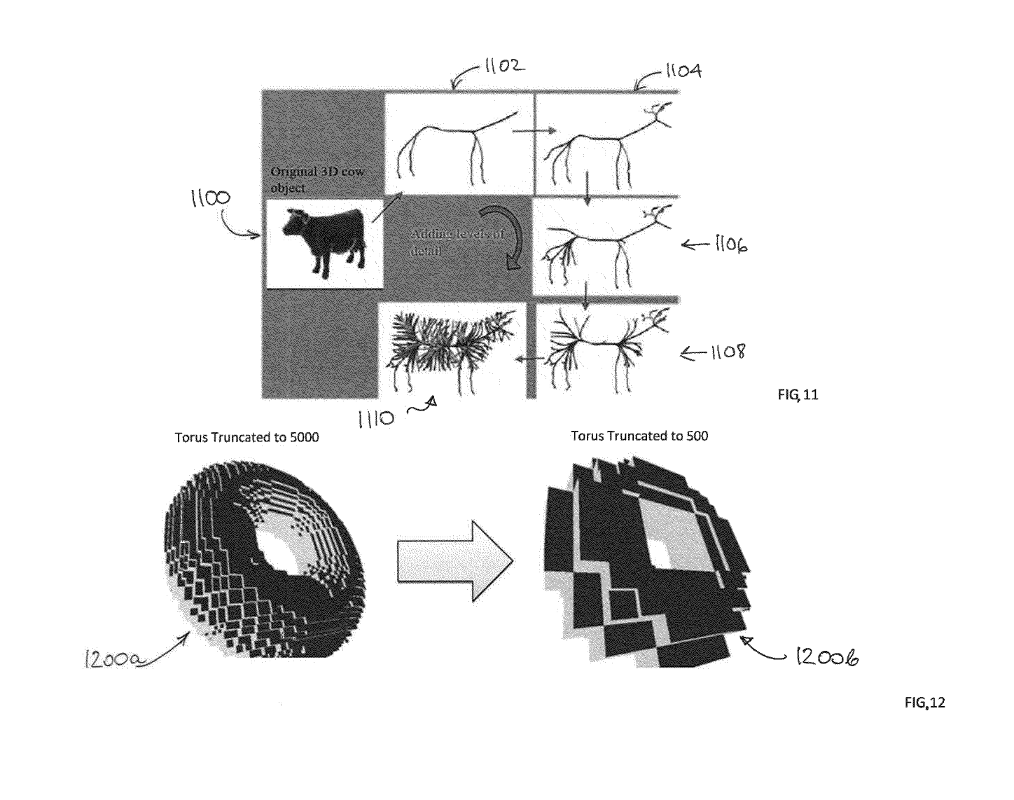

With regard to FIG. 12, an illustration of a pair of torus structures 1200a and 1200b with a complex outer skeleton simplified through use of a truncation process that represents the 3D object is shown. One reason for using an outer skeleton is that inner skeletons may not always be possible or desirable when a 3D object is scanned using a 3D scanner, for example. The truncation process may utilize a modified process of FIG. 4, but rather than using a skeleton, such as that shown in FIG. 11, uses functions that produce layers with certain geometry, such as triangular facets that form surfaces. Torus structure 1200a is shown with 5000 modeling elements, such as triangular facets, while torus structure 1200b is shown with 500 modeling elements. The resolution difference between the two different torus structures 1200a and 1200b is relevant as a higher probability of determining a copy of a protected rights 3D object is higher with higher resolution.

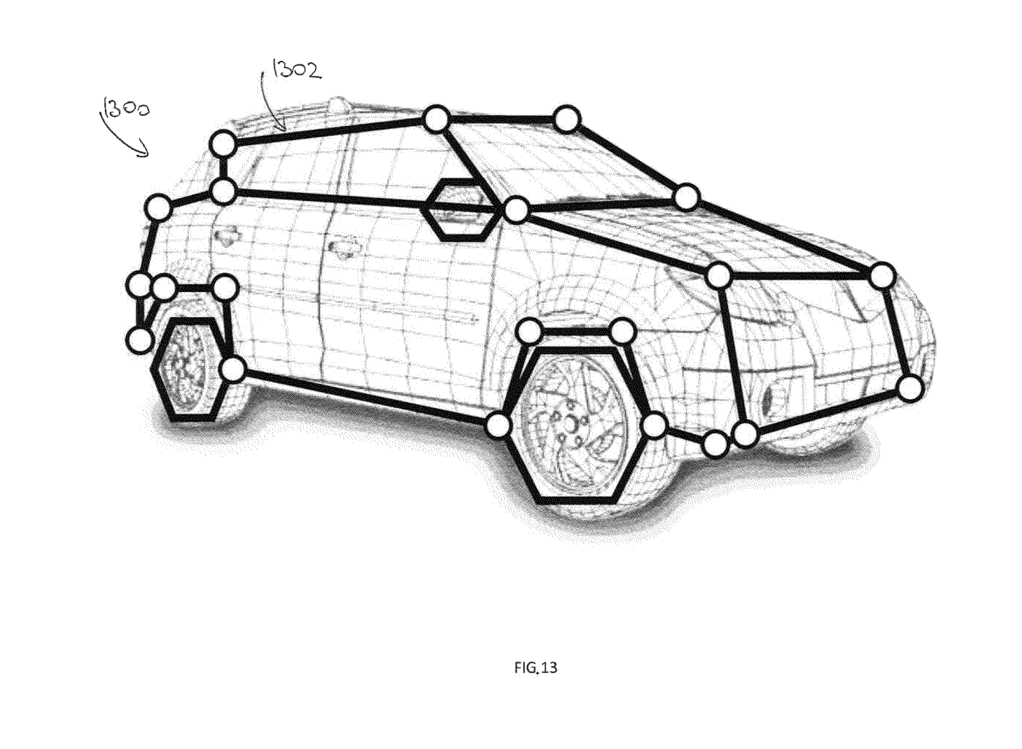

With regard to FIG. 13, an illustration of an illustrative automobile 1300 with a truncation skeleton 1302 of the outer portion of the automobile is shown. In some cases, the use of the truncated skeleton 1302 may be sufficient to (i) determine that the 3D object is a vehicle and (ii) determine the type of vehicle. Still yet, if a component of the vehicle is to be 3D printed or otherwise manufactured, then a determination may be made as to whether rights restrictions exist for the component. Again, in order to determine such detail, sufficient parameters have to be available as a result of the indicators or functions used to create the resulting parameters, as provided in FIG. 4.

A cloud computing platform could be used for realization of processes described above. Cloud technologies for example Hadoop, Cassandra, etc. could be used for this platform, however, non-cloud software frameworks and programming languages also could be used. Depending on business needs, a different final setup of the computer system which implements the process described above could be done. For example, it could be configured only for distinguishing firearms and weapons based on 3D model of the object. It could be setup in a way that all classes of objects are defined, for example, architecture, vehicles, aircrafts, furniture, plants, food, animals, electronics, characters, weapons, anatomy, accessories, DNA and molecules, etc.

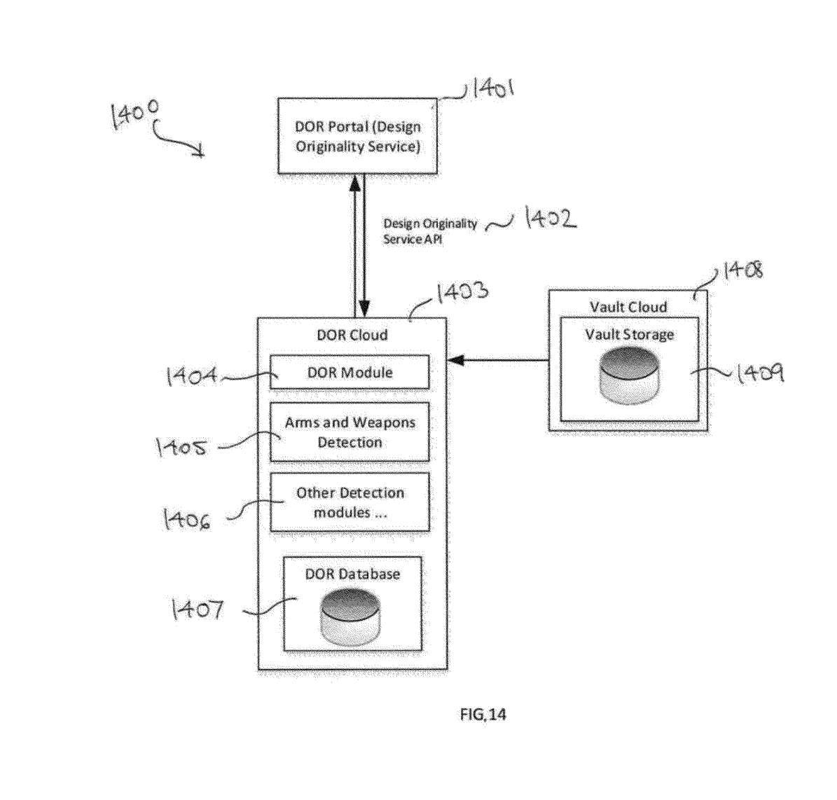

The architectural view of the software solution according to one embodiment 1400 is provided on FIG. 14. There is a Design Originality Recognition (DOR) Portal 1401 for providing design originality service. This is an end point for customers to access the service through, e.g., a web interface. There is an API 1402, which is an end point to DOR cloud solution 1403. DOR Cloud has several modules. DOR module 1404 which includes methods described above. Some of the methods may be implemented separately, for example Arms and Weapons detection module 1405 could be implemented separately in order to load balance the cloud, as for example in real application arms and weapons detection will have more specific indicators and more specific business rules that are not needed to be applied to other 3D models. Other detection modules 1406 could be implemented in a similar way. There is a DOR database 1407, which stores intermediate and final results of DOR processes. 3D model could be loaded from DOR portal 1401 or from any other storage including Vault Cloud 1408 and Vault Storage 1409. Vault Cloud stores 3D models in a secured or unsecured way, every 3D model could be split into many pieces, and each peace may be encrypted with its own encryption key. DOR cloud can consist of one or many (e.g., hundreds or thousands) hardware or virtual computing units.

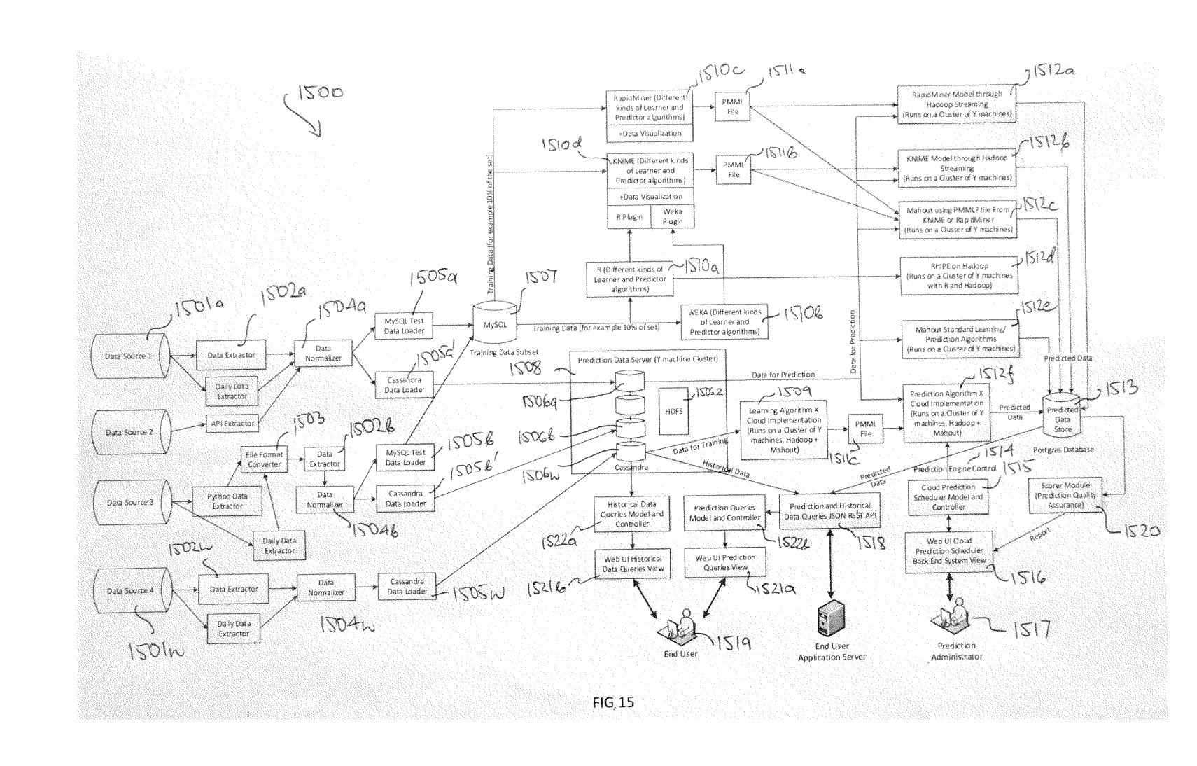

The technical view of the software solution for 3D models comparison according to one embodiment 1500 is provided on FIG. 15. Technologies and types of software are not limited or fixed, FIG. 15 shows just one example of implementation. Data sources 1501a-1501n are any sources of 3D models, for example CAD files, STL files, etc. from different locations, for example Data Source 2 could be Thingiverse database or web site, Data Source 1 could be a database with 3D models, Data Source 4 could be a computer file storage. There is a set of extractors 1502a to 1502n and file format converters 1503 when needed. 3D models that are shown as Data on the FIG. 15 are extracted and normalized after conversion. Normalization modules 1504a to 1504n shown on FIG. 15 also include indicators calculation software. Using Database loaders 1505a to 1505n 3D models and results of indicators are loaded to corresponding databases 1506a to 1506n, it could be a distributed database like Cassandra, just single database, storage or cloud storage, like HDFS 1506z. There are several types of databases (test database and prediction database), where 3D models and resulting parameters of indicators are loaded. Training Data Subset 1507 shown as MySQL on the FIG. 15 is used for storing training data for data mining and machine learning algorithms training modules implemented in different types of frameworks. The rest of the data is stored in Prediction Data Server database 1508. This database is also used to provide training data for proprietary training and prediction algorithm (Learning Algorithm X cloud implementation) 1509.

Data usually goes to different open source and non-open source implementations of data mining and machine learning algorithms 1510a, 1510b, 1510c and 1501d (for example R, KNIME, RapidMiner, Weka, etc.), which training modules or setups prepare PMML files 1511a, 1511b and 1511c. PMML files define models of predictive analytics and data mining. PMML files are used to transfer training information to prediction modules or setups of data mining and machine learning algorithms 1512a to 1512f (for example KNIME, RapidMiner, Mahout, custom Hadoop algorithm, RHIPE, or proprietary, etc). Predicted data is stored to Predicted Data Store 1513, which consists of information about 3D model classes, types, differences between them, similarities, originalities, possible arms and weapons, etc. Prediction engine 1514 is controlled through Cloud Prediction Scheduler Model and Controller 1515, and is accessible by a user, who is predictive administrator 1517 through Web UI Cloud Prediction Scheduler Back End System View 1516. There could be an API, Prediction and Historical Data Queries JSON REST API 1518 for getting predicted information from other applications, servers, services, etc. Using Web API 1521a and 1521b end user 1519 can make requests both to 3D models historical datasets using Historical Data Queries Model and Controller 1522a, and to prediction databases using Prediction queries model and controller 1522b, so that end user can assess final results, and if needed, tune parameters for algorithms, etc in a prediction administrator role. There is a Scorer Module 1520, which make prediction quality assurance and reports to Prediction Administrator 1517.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method of enforcing 3D restricted rights in a rapid manufacturing and prototyping environment, said method comprising:
in response to receiving a 3D object data representative of a 3D object, performing, by a computing device, at least one function on the 3D object data to determine a parameter set for each respective at least one function;
applying, by the computing device, at least one business rule to each parameter set for each respective at least one function;
performing, by the computing device, at least one algorithm to determine whether at least a portion of the 3D object matches a rights restricted 3D object; and
in response to determining that at least a portion of the 3D object matches a restricted rights 3D object, causing, by the computing device, an action to be taken, otherwise, in response to determining that at least a portion of the 3D object does not match a restricted rights 3D object, enabling, by the computing device, the 3D object to be rapid manufactured or prototyped.

2. The method according to claim 1, wherein determining whether the at least a portion of the 3D object matches a rights restricted 3D object includes determining a probability factor that the at least a portion of the 3D object matches the rights restricted 3D object.

3. The method according to claim 1, wherein performing at least one function includes calculating a number of vertices of which the 3D object includes.

4. The method according to claim 1, wherein applying at least one business rule includes checking the parameter set and making a determination based on the parameter set, and wherein making a determination on the parameter set includes making a determination that the 3D object is a firearm or weapon.

5. The method according to claim 4, wherein making a determination includes voting using the 3D object data set for a particular 3D object device represented by the 3D object data.

6. The method according to claim 1, further comprising normalizing the 3D object data prior to performing the at least one function.

7. The method according to claim 6, wherein normalizing includes scaling the 3D object data to be comparable to other 3D object data representative of the rights restricted 3D object to which the 3D object is to be compared.

8. The method according to claim 1, wherein causing an action to be taken includes preventing the 3D object to be rapid manufactured or prototyped.

9. A system of enforcing 3D restricted rights in a rapid manufacturing and prototyping environment, said system comprising:
a storage unit configured to store restricted right 3D objects;
a memory configured to store data;
a computing device in communication with said storage unit and memory, and configured to:
in response to receiving a 3D object data representative of a 3D object, perform at least one function on the 3D object data to determine a parameter set for each respective at least one function;
apply at least one business rule to each parameter set for each respective at least one function;
perform at least one algorithm to determine whether at least a portion of the 3D object matches a rights restricted 3D object; and
in response to determining that at least a portion of the 3D object matches a restricted rights 3D object, cause an action to be taken, otherwise, in response to determining that at least a portion of the 3D object does not match a restricted rights 3D object, enable the 3D object to be rapid manufactured or prototyped.

10. The system according to claim 9, wherein said computing device, in determining whether the at least a portion of the 3D object matches a rights restricted 3D object, is further configured to determine a probability factor that the at least a portion of the 3D object matches the rights restricted 3D object.

11. The system according to claim 9, wherein said computing device, in performing at least one function, is further configured to calculate a number of vertices of which the 3D object includes.

12. The system according to claim 9, wherein said processing unit, in applying at least one business rule, is further configured to check the parameter set and make a determination based on the parameter set, and wherein making a determination on the parameter set includes making a determination that the 3D object is a firearm or weapon.

13. The system according to claim 12, wherein said processing unit, in making a determination, is further configured to vote, using the 3D object data set, for a particular 3D object device represented by the 3D object data.

14. The system according to claim 9, wherein said processing unit is further configured to normalize the 3D object data prior to performing the at least one function.

15. The system according to claim 14, wherein said processing unit, in normalizing, is further configured to scale the 3D object data to be comparable to other 3D object data representative of the rights restricted 3D object to which the 3D object is to be compared.
